(19) United States
(12) Patent Application Publication
(10) Pub. No.: US 2017/0370248 A1
(43) Pub. Date: Dec. 28, 2017

(54) HOUSING FOR A ROTOR OF AN ENGINE

(71) Applicant: Rolls-Royce Deutschland Ltd & Co KG, Blankenfelde-Mahlow (DE)

(72) Inventor: Robert KWIATKOWSKI, Berlin (DE)

(21) Appl. No.: 15/629,219

(22) Filed: Jun. 21, 2017

(30) Foreign Application Priority Data
Jun. 23, 2016 (DE) 10 2016 211 231.7

(51) Int. Cl. F01D 25/24; F01D 25/26; F01D 25/28

(52) U.S. Cl. CPC F01D 25/243; F01D 25/28; F01D 25/265; F05D 2230/80; F05D 2230/72; F01D 25/24; F05D 2220/32; F01D 25/26; F05D 2260/02; F05D 2260/80; F05D 2220/3216

(57) ABSTRACT

A housing for a rotor of an engine is provided. The housing forms an interior space for accommodating the rotor that is defined by a housing wall and the housing wall (W) circumferentially surrounds the rotor that is accommodated inside the housing. The housing has at least one service opening which is provided in the housing wall for maintenance and/or repair work and through which the interior space is accessible from the outside. The service opening is provided in the area of two facing flange sections of the housing, wherein the service opening is closed by at least one closure part that is received at least partially inside a gap formed between the facing flange sections and fixated therein in a releasable manner.

### REFERENCE TO RELATED APPLICATION

This application claims priority to German Patent Application No. 10 2016 211 231.7 filed on Jun. 23, 2016, the entirety of which is incorporated by reference herein.

### BACKGROUND

The invention relates to a housing for a rotor of an engine.

With a housing wall, a generic housing defines an interior space for receiving a rotor, wherein the housing wall circumferentially surrounds the rotor that is accommodated inside the housing. Accordingly, the housing can for example be embodied as a compressor housing for a compressor of a gas turbine engine that particularly circumferentially surrounds the rotating blade wheels of the compressor and through which the flow can be passed in the axial direction. In particular for maintenance and repair purposes, it is known to provide at least one service opening in the housing wall of such a housing, with the interior space accommodating the rotor being accessible through it from the outside. Such a service opening may for example serve for inserting a tool, such as for example a boroscope, in order to determine the possible presence of any damage to the (rotating or stationary) blade wheels, that is, to the rotor blades and the guide vanes, for example.

In practice, such a service opening is comparatively small, for example having a diameter of less than 10 mm. It is barely possible to insert tools for the purpose of repairing structural components of the engine which are located inside the interior space, in particular of the rotor. However, it is regularly also not readily possible to simply enlarge the service opening, especially since the service opening is supposed to be closed during operation and closure parts that have to be fixed for this purpose at the housing wall have to be fixated in a comparatively elaborate manner for the service opening to be reliably closed.

### SUMMARY

It is thus an objective of the invention to improve a housing for a rotor of an engine in this respect, and in particular to make it possible to render the access easier via a service opening in a housing wall of the housing.

This objective is achieved through a housing with features as described herein.

Here, a housing, for example a compressor housing for a compressor of an engine in the housing wall, has at least one service opening that is provided for maintenance and/or repair works in the area of two facing flange sections of the housing, wherein the service opening is closed by at least one closure part that is at least partially received and fixated in a releasable manner inside a gap which is formed between the facing flange sections.

Thanks to the arrangement of the at least one closure part inside a gap between two facing flange sections, a sufficiently large service opening can be readily provided and can be closed by a closure part that can be fixated inside the gap in a safe manner. Here, the house wall can be embodied in one piece, so that the two facing flange sections that radially protrude at an outer side of the housing with respect to the rotational axis of the rotor serve exclusively or predominantly for fixating the closure part. However, in an alternative embodiment variant, the housing can also be embodied in multiple parts, wherein in that case two housing parts of the housing are connected to each other via the two flange sections. Here, the two housing parts can also be connected—preferably in a symmetrical manner—via multiple flange sections that are assigned to each other by pairs. However, in that case a gap between two flange sections forming a service opening or making it accessible is provided only at one of multiple pairs of flange sections in one embodiment variant. Alternatively, it can also be provided that, through the multiple pairs of flange sections by which the (at least) two housing parts are connected to each other, multiple service openings are closed by respectively at least one closure part and are accessible, where required.

In one embodiment variant, at least one of the flange sections has at least one attachment hole which is aligned with the opening of closure part that is received inside the gap in accordance with the intended use, and through which an attachment element is passed for the releasable fixation of the closure part. The at least one attachment hole of the flange section is thus provided as a passage opening for inserting or screwing in an attachment element, such as for example a threaded bolt, in order to thereby fixate the closure part at the flange section and inside the gap. For this purpose, the opening of the closure part can be embodied as a blind hole, in particular as a blind hole bore or a passage opening. In the case of an embodiment as a passage opening, a section of the attachment element is accordingly also guided through the closure part to be subsequently fixated at the facing flange section, for example by screwing the attachment element to it or by securing it with a nut.

In a multi-part housing a fixation of two housing parts to each other can also be realized by means of the at least one attachment element through which the at least one closure part is fixated in a releasable manner inside the gap. Thus, the attachment element, which may for example be a threaded bolt, does not only serve for the purpose of fixating the closure part, but also for connecting the two housing parts to each other in accordance with the intended use.

The closure part can for example be embodied so as to have a longitudinal extension and in particular to be bar-shaped. Here, a bar-shaped design of the at least one closure part in particular includes that the closure part has a cuboid-shaped base body that is inserted inside the gap which if formed between the two flange sections, and that it is fixated herein by means of at least one separate attachment element.

In one embodiment variant, the at least one closure part can taper off towards the rotational axis of the rotor in the cross-section. Thus, the closure part has at least one obliquely extending side surface, which can thus for example extend in a ramp-like manner. In particular, the closure part can be embodied so as to be wedge-shaped in the cross-section.

Alternatively or additionally, the closure part can taper off in an extension direction that is parallel to the rotational axis of the rotor. Thus, the closure part can be embodied with a taper that extends in the axial direction in order to facilitate an insertion in parallel to the rotational axis of the rotor, where required.

In one variant, the at least one closure part forms at least one projection at an outer side, which the projection being located outside of the gap and protruding from a base body of the closure part which is received between the flange sections obliquely with respect to the extension direction of the gap. In particular in this variant, the closure part can consequently be embodied so as to be L-shaped or T-shaped in the cross-section at least in the area of the projection.

In one embodiment variant, multiple (at least two) closure parts are received at least partially inside the gap that is formed between the facing flange sections. Accordingly, at least two closure parts for closing a service opening are arranged inside the gap. Where required, the closure parts can also be detached and removed from the gap independently of each other, for example in order to vary the size of the service opening. For example, if only an access for a boroscope is required, it may be sufficient to remove only one of the multiple closure parts from the gap. But for any repair work that may be necessary, multiple closure parts can be removed and thus a larger part of the service opening can be uncovered.

In order to make the inside of the housing accessible from different locations, it can be provided in one embodiment variant that two facing flange sections with a service opening closed by at least one closure part are provided in the housing wall at least at one further location. As has already been mentioned, here the pairs of facing flange sections that respectively define a gap for the releasable fixation of at least one closure part in between them can be provided at the housing wall of the one-part or multi-part housing so as to be symmetrical or asymmetrical with respect to the rotational axis.

In general, it is not absolutely necessary that the gap inside of which the at least one closure part is received extends at the housing wall in parallel to the rotational axis of the rotor and thus in a linear manner along a longitudinal direction. For example, it can also be provided that the gap extends at an angle with respect to the rotational axis of the rotor. In the latter case, the closure part that is to be inserted into the gap can be embodied in a curved manner in the case of a tubular housing having a circular cross-section.

In one embodiment variant, the gap inside of which the at least one closure part is received has a gap length that represents only a fraction of the length by which the housing extends along the longitudinal direction that is parallel to the rotational axis. Thus, the gap for the service opening and the at least one closure part do not extend along the entire length of the housing, so that the housing is completely slitted by the gap in the longitudinal direction. Rather, the gap is embodied to be shorter at the housing wall. But of course it is likewise possible to alternatively provide a longitudinally slitted housing, with the gap extending across the entire length of the housing.

A housing according to the invention can for example be embodied as a compressor housing for accommodating at least one rotor of a compressor of the engine. As has already been explained, the housing can be designed so as to have at least two parts. Alternatively or additionally, it is provided in one embodiment variant that the gap which is formed between two facing flange sections extends only over a part of the compressor stages that are accommodated inside the compressor housing.

In general, when it comes to an engine with a rotor that is received inside a housing according to the invention, in particular the accessibility of the rotor through the service opening for the purpose of maintenance and/or repair work can be considerably improved. Here, the advantages that can be thus achieved are not limited to a compressor of the engine and thus to a compressor housing. A housing according to the invention can also be used for receiving a rotor of the turbine of the engine, in particular of a gas turbine engine.

### BRIEF DESCRIPTION OF THE DRAWINGS

Possible embodiment variants of the invention are illustrated in an exemplary manner in the accompanying Figures.

FIG. 1 shows, by sections, an exploded view of an exemplary embodiment of a housing according to the invention, having a gap the extends longitudinally between 2 flange sections as well as a service opening that is accessible through the same and that has a bar-like closure part.

FIG. 2 shows a second embodiment variant with multiple separate closure parts for closing a service opening in a rendering corresponding to FIG. 1.

FIGS. 3A-30 show different variants of a bar-shaped closure part respectively in perspective renderings.

FIG. 4 shows a schematic sectional rendering of a gas turbine engine in which a rotor according to the invention is used.

### DETAILED DESCRIPTION

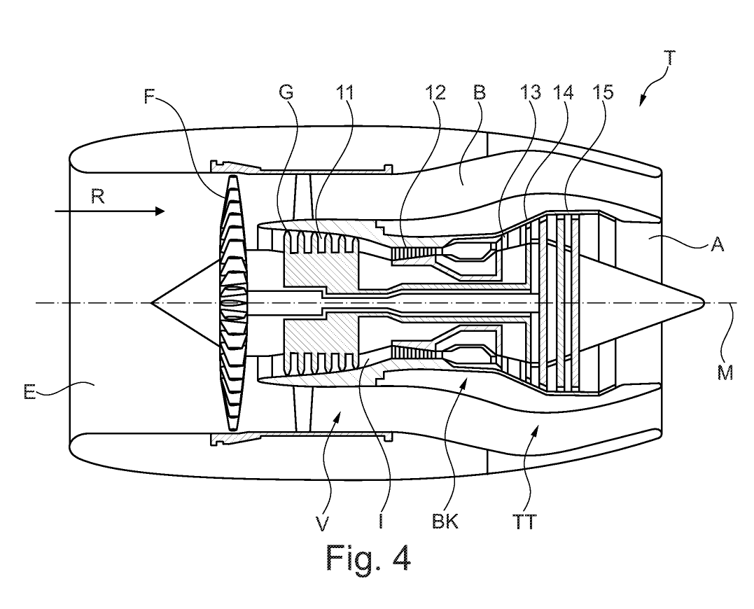

FIG. 4 shows a schematic sectional rendering a (gas turbine) engine T, in which the individual engine components are arranged in succession along a central axis or a rotational axis M. Air is suctioned in along an entry direction E at an inlet or intake E of the engine T by means of a fan F. This fan F is driven by a shaft that is set into rotation by a turbine TT. Here, the turbine TT connects to a compressor V, which for example comprises a low-pressure compressor 11 and a high-pressure compressor 12, as well as a medium-pressure compressor, where necessary. On the other hand, the fan F supplies air to the compressor V, on the other hand, it supplies air to a bypass channel B for thrust generation. The air that is conveyed by means of the compressor V eventually reaches a combustion chamber section BK, where the drive energy for driving the turbine TT is generated. For this purpose, the turbine TT has a high-pressure turbine 13, a medium-pressure turbine 14, and a low-pressure turbine 15. The turbine TT drives the fan F through the energy released during combustion in order to then generate the necessary thrust through the air that is conveyed into the bypass channel B. At that, the air is discharged from the bypass channel B in the area of an outlet A at the end of the engine T, where the exhaust gases flow out of the turbine TT in the outward direction, with the outlet A usually having a thrust nozzle.

The compressor V has a (compressor) housing G, with the rotor of the compressor V being accommodated in the interior space I of the housing G. In order to make the interior space I accessible from the outside for performing maintenance and/or repair work, in practice the housing G regularly has smaller service openings with a diameter of less than 10 mm. Then, a boroscope can for example be inserted into the interior space I through such a service opening in order to identify possible damage. However, the size of the service openings is usually not dimensioned in such a way that tools for repair can be inserted through it. A simple enlargement of the service opening is also not readily possible, since a reliable closing has to be ensured for operation.

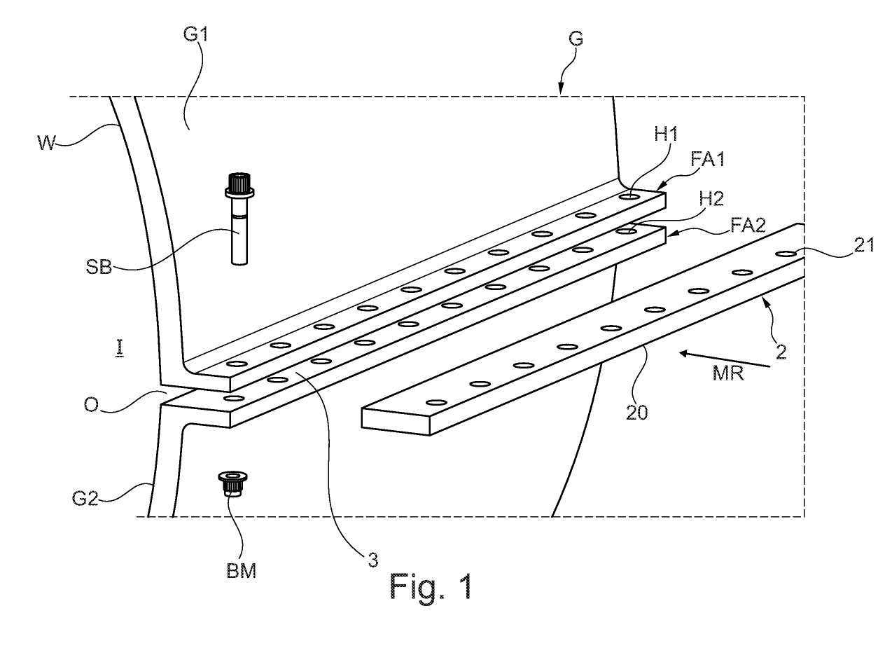

The invention according to the invention provides a remedy in this context, with possible embodiment variants of it being illustrated in an exemplary manner based on the FIGS. 1, 2 and 3A to 3C.

Here, FIG. 1 shows, in sections, the housing G of the compressor V that extends circumferentially about the central axis/rotational axis M with a housing wall W. In the present case, a longitudinally extending service opening O in the form of a continuous slit is provided in the housing wall W. Here, the service opening O extends in parallel to the rotational axis M.

Through the longitudinal slit of the service opening O, the housing G is divided in two housing parts G1 and G2 that are connected to each other in the area of the service opening O by means of facing flange sections FA1 and FA2. The two flange sections FA1 and FA2 project in the radial direction at an outer lateral surface of respectively one housing part G1 or G2 with respect to the rotational axis M. Here, the two flange sections FA1 and FA2 face each other in such a manner that a longitudinally extending gap 3 is formed in between them. This gap 3 opens directly into the service opening O, so that a tool can be inserted into the interior space I of the housing G via the gap 3 and through the service opening O.

In order to close the service opening O for the operation of the gas turbine engine T, a bar-shaped closure part 2 is provided that can be inserted into the gap 3 along a mounting direction MR, completely closing the service opening O in the mounted state in accordance with the intended use. In the present case, the mounting direction MR extends substantially radially inward.

For fixating the closure part 2 that is received inside the gap 3, the closure part 2 has multiple passage openings 21 which are arranged in series behind each other. These passage openings 21 are embodied by bores at a longitudinally extending cuboid-shaped base body 20 of the closure part 2. In a state in which the closure part 2 is inserted into the gap 3 between the two flange sections FA1 and FA2 in accordance with the intended use, the passage openings 21 of the closure part 2 are positioned in an aligned manner opposite the attachment holes H1 and H2 of the flange sections FA1 and FA2. An attachment element—here in the form of a threaded bolt SB—can be attached at the flange sections FA1 and FA2, so that it connects the flange sections FA1 and FA2 to each other, and passes through a passage opening 21 of the closure part 2. For final fixation, In the present case a fastening nut BM is subsequently screwed onto the end of a threaded bolt SB that is inserted from a first side. Then, the closure part 2 is fixated inside the gap 3 by means of multiple attachment elements, and the two housing parts G1 and G2 are connected to each other in this manner. However, the fixation of the closure part 2 can be detached for performing maintenance and/or repair work, so that the closure part 2 can be removed from the gap 3, and the service opening O is uncovered.

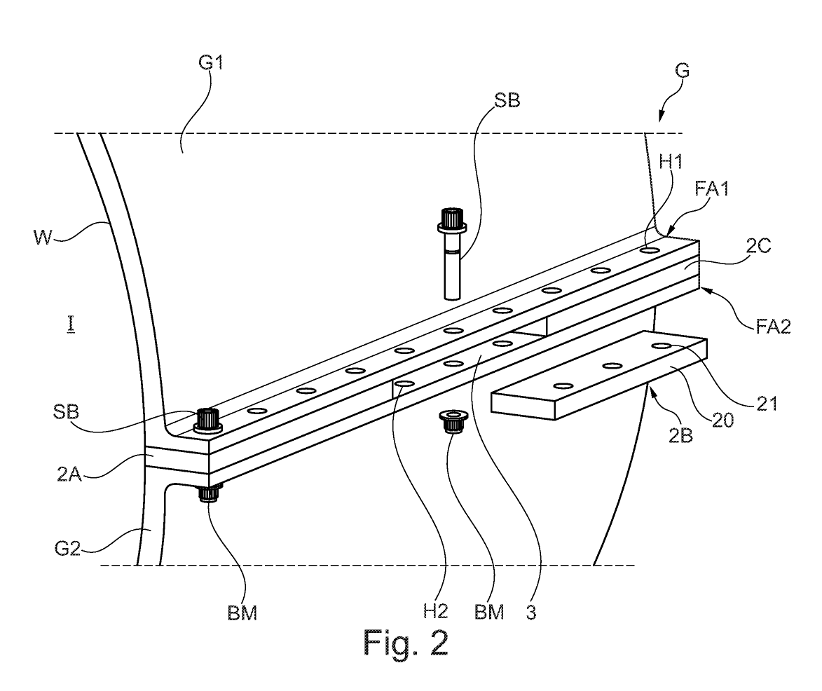

In the embodiment variant of FIG. 2, the service opening O can be closed by means of multiple—in the present case at least three—separate, respectively bar-shaped closure parts 2A, 2B and 2C. The individual closure parts 2A, 2B and 2C are embodied so as to be shorter than the continuous closure part 2 of the embodiment variant of FIG. 1. Thus, the closure parts 2A, 2B and 2C respectively have a length along the rotational axis M that represents only a fraction of the total length of the housing G.

Due to the fact that the individual closure parts 2A, 2B and 2C can be removed from the gap 3 independently of each other, the part of the service opening O to be uncovered can be varied based on the number of the closure parts 2A, 2B and 2C that are removed. Again, it should be understood that the service opening O and thus also the gap 3 do not have to extend in parallel to the rotational axis M across the total length of the housing G. Thus, already the length of the service opening O and the length of the gap 3 can respectively represent only a fraction of the total length of the housing G.

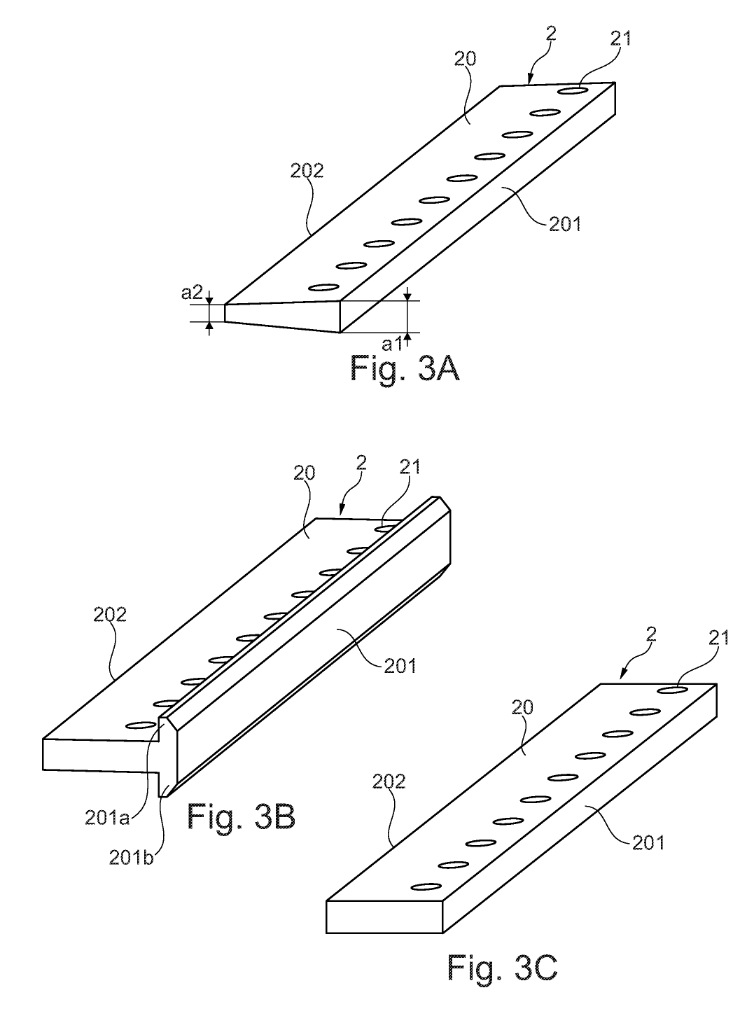

FIGS. 3A, 3B and 3C show individual variants for differently designed closure parts 2 respectively in a perspective rendering and enlarged view. Here, the design of the closure part 2 of FIG. 3C corresponds to the variant of FIG. 1. What is provided here is a bar-shaped closure part 2 with a cuboid-shaped longitudinally extending base body 20, in which a radially outer front side 201 and a radially inner front side 202 have a corresponding height and length.

In contrast to that, the closure part 2 of FIG. 3A is embodied so as to taper off in the cross-section, and thus to have a wedge shape. Thus, a radially inner front side 202 of the closure part 2 of FIG. 3A has a lower height a2 than a radially outer front side 201 having a height a1 (a2>a1).

In the variant of FIG. 3B, the radially outer front side 201 of the closure part 2 is embodied with two facing projections 201a and 201b. These projections 201a and 201b respectively protrude in a substantially perpendicular manner from the cuboid-shaped, longitudinally extending base body 20, thus protruding outside of the gap 3 substantially obliquely to a longitudinal extension direction of the gap 3 in the installed state in accordance with the intended use. Due to the projections 201a and 201b, the closure part 2 of FIG. 3B appears T-shaped in the cross-section. Thus, in the state in which the closure part 2 is inserted into the gap 3 in accordance with the intended use, each projection 201a, 201b adjoins a radially outer side of an associated flange section FA1 or FA2 outside of the gap 3. Thanks to the projections 201a and 201b it is for example avoided that the closure part 2 is inserted too far into the gap 3 along the mounting direction MR. Thus, the projections 201a and 201b determine the radial position of the closure part 2 between the flange sections FA1 and FA2 in accordance with the intended use, so that the passage openings 21 of the closure part 2 are positioned in an aligned manner opposite the attachment holes H1 and H2 of the two flange sections FA1 and FA2, and the multiple threaded bolts SB can be inserted in an unproblematic manner for fixing.

### PARTS LIST

11 low-pressure compressor
12 high-pressure compressor
13 high-pressure turbine
14 medium-pressure turbine
15 low-pressure turbine
2, 2A, 2B, 2C closure part
20 base body
201, 202 front side
201a, 201b projection
21 passage opening
3 gap
A outlet
a1, a2 height
B bypass channel
BK combustion chamber section
BM fastening nut
E inlet/intake
F fan
FA1, FA2 flange section
G housing
G1, G2 housing part
H1, H2 attachment hole
I interior space
M central axis/rotational axis
MR mounting direction
O service opening
R entry direction
SB threaded bolt (attachment element)
T gas turbine engine
TT turbine
V compressor
W housing wall

1. A housing for a rotor of an engine, wherein the housing forms an interior space for accommodating the rotor that is defined by a housing wall, and the housing wall circumferentially surrounds the rotor received inside the housing, and wherein the housing has at least one service opening which is provided in the housing wall for maintenance and/or repair work and through which the interior space is accessible from the outside, wherein the service opening is provided in the area of two facing flange sections of the housing, and the service opening is closed by at least one closure part which is received at least partially inside a gap formed between facing flange sections and is fixated in a releasable manner.

2. The housing according to claim 1, wherein the housing is embodied so as to have multiple parts, and that two housing parts of the housing are connected to each other by means of the two flange sections.

3. The housing according to claim 1, wherein at least one of the flange sections has at least one attachment hole which is aligned with an opening of the closure part and through which an attachment element is passed for the releasable fixation of the closure part.

4. The housing according to claim 2, wherein at least one of the flange sections has at least one attachment hole which is aligned with an opening of the closure part and through which an attachment element is passed for the releasable fixation of the closure part and wherein the at least one closure part is fixated in a releasable manner inside the gap through at least one attachment element by means of which the two housing parts are also connected to each other.

5. The housing according to claim 1, wherein the at least one closure part is embodied so as to be longitudinally extending and/or bar-shaped.

6. The housing according to claim 1, wherein the at least one closure part tapers off in the cross-section towards the rotational axis of the rotor.

7. The housing according to claim 6, wherein the at least one closure part is embodied so as to be wedge-shaped in the cross-section.

8. The housing according to claim 1, wherein the at least one closure part forms at least one projection at an outer side, with the projection being positioned outside of the gap and protruding obliquely with respect to an extension direction of the gap from a base body of the closure part that is received between the flange sections.

9. The housing according to claim 1, wherein the at least one closure part is embodied so as to be L-shaped or T-shaped in the cross-section.

10. The housing according to claim 1, multiple closure parts are at least partially received inside the gap formed between the facing flange sections.

11. The housing according to claim 1, wherein two facing flange sections with a service opening that is closed by at least one closure part are provided in the housing wall at least at one further location.

12. The housing according to claim 1, wherein the gap inside of which the at least one closure part is received extends at the housing wall in parallel or at an angle with respect to the rotational axis of the rotor.

13. The housing according to claim 1, wherein the gap inside of which the at least one closure part is received has a gap length which represents only a fraction of the length by which the housing extends along a longitudinal direction in parallel to the rotational axis.

14. The housing according to claim 1, wherein the gap inside of which the at least one closure part is received extends across the entire length of the housing by which the housing extends along a longitudinal direction in parallel to the rotational axis.

15. The housing according to claim 1, wherein the housing is embodied as a compressor housing for accommodating at least one rotor of a compressor of the engine.

16. An engine with a rotor that is received inside the housing according to claim 1.
